(19) United States
(12) Patent Application Publication
(10) Pub. No.: US 2026/0147264 A1
(43) Pub. Date: May 28, 2026

(54) ILLUMINATION SYSTEM AND PROJECTION APPARATUS

(71) Applicant: Coretronic Corporation, Hsin-Chu (TW)

(72) Inventors: Yi-Hsuang Weng, Hsin-Chu (TW); Chun-Hsin Lu, Hsin-Chu (TW); Wen-Chieh Chung, Hsin-Chu (TW)

(73) Assignee: Coretronic Corporation, Hsin-Chu (TW)

(21) Appl. No.: 19/396,230

(22) Filed: Nov. 20, 2025

(30) Foreign Application Priority Data
Nov. 22, 2024 (CN) 202411680140.8

(51) Int. Cl. G03B 21/20; G03B 33/12

(52) U.S. Cl. CPC G03B 21/204; G03B 21/2066; G03B 33/12

(57) ABSTRACT

An illumination system including a light source module, a light splitting/combining module, a wavelength conversion element and a light splitting element is provided. The light splitting/combining module causes the first laser beam from the light source module to pass through a first portion of the light splitting element and to transmit to the wavelength conversion element, and causes the second laser beam from the light source module to pass through a second portion of the light splitting element. The second portion reflects the first laser beam. The first portion and the second portion reflect a first converted beam from the wavelength conversion element to form a second converted beam. The first laser beam, the second laser beam and the second converted beam form an illumination beam. The illumination system and a projection apparatus having the same provide the illumination beam with a color gamut range required by the projection apparatus.

### CROSS-REFERENCE TO RELATED APPLICATION

This application claims the priority benefit of China application serial no. 202411680140.8, filed on Nov. 22, 2024. The entirety of the above-mentioned patent application is hereby incorporated by reference herein and made a part of this specification.

### BACKGROUND

### Technical Field

The disclosure relates to an illumination system and a projection apparatus.

### Description of Related Art

A projector is provided with an illumination system, a light modulation system, and a projection lens, wherein the illumination system is configured to provide an illumination beam including light beams of various colors required for forming a color image. The light modulation system then converts the illumination beam into an image beam with an image pattern and a color distribution. Finally, the projection lens projects the image beam to form an image.

In the commonly used technologies about the illumination systems generating illumination beams, typically a laser beam is directed onto a wavelength conversion device having different wavelength conversion areas, so as to generate converted lights with different wavelength ranges. The different converted lights then pass through corresponding optical filters to obtain the wavelength ranges required by the projector design, thereby generating the desired colored light beams.

However, as the color gamut designed for the projector becomes larger, the required colored light beam spectrum becomes narrower. Consequently, more of the converted lights are filtered out by the optical filters, resulting in low system efficiency. This also means that the illumination beam passing through the optical filters has lower brightness.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection apparatus configured to provide an illumination beam with high brightness and a color gamut range required by the projection apparatus.

Other objectives and advantages of the disclosure will be further understood from the technological features disclosed herein.

To achieve one or part or all of the above objectives or other objectives, an embodiment of the disclosure provides an illumination system configured to provide an illumination beam. The illumination system comprises a light source module, a wavelength conversion element, a light splitting/combining module, and a light splitting element. The light source module is configured to provide a first laser beam and a second laser beam to the light splitting/combining module along a first direction. The wavelength conversion element comprises a wavelength conversion area and a non-wavelength conversion area. The wavelength conversion area and the non-wavelength conversion area are configured to enter a transmission path of the first laser beam from the light splitting/combining module in different time periods. The non-wavelength conversion area is configured to reflect the first laser beam. The wavelength conversion area is configured to convert the first laser beam to generate a first converted beam. A wavelength range of the first converted beam partially overlaps with a wavelength range of the second laser beam. The light splitting element is disposed between the light splitting/combining module and the wavelength conversion element, wherein the light splitting element comprises a first portion and a second portion disposed adjacent to each other. The light splitting/combining module is disposed between the light source module and the light splitting element. The light splitting/combining module is configured to transmit the first laser beam along the first direction to the first portion of the light splitting element, and swerve an optical path of the second laser beam so that the second laser beam transmits to the second portion of the light splitting element along a second direction, wherein the first direction is not parallel to the second direction. The first portion of the light splitting element is configured to allow the first laser beam from the light splitting/combining module to pass through. The second portion of the light splitting element is configured to reflect the first laser beam from the wavelength conversion element and allow the second laser beam from the light splitting/combining module to pass through. The first portion and the second portion are configured to reflect at least a part of the first converted beam from the wavelength conversion element to form a second converted beam. The first laser beam from the non-wavelength conversion area and the second laser beam exit the light splitting element along the second direction from the second portion of the light splitting element. The second converted beam exits the light splitting element along the second direction from the first portion and the second portion of the light splitting element, and at least one of the first laser beam, the second laser beam, and the second converted beam serves as the illumination beam and is emitted from the illumination system.

According to an embodiment, the disclosure further provides a projection apparatus, including the illumination system as described in all previous embodiments, a light modulation device, and a projection lens. The illumination system is configured to provide an illumination beam. The light modulation device is disposed on a transmission path of the illumination beam and configured to convert the illumination beam into an image beam, and the projection lens is disposed on a transmission path of the image beam and configured to project the image beam out of the projection apparatus.

Based on the above, the illumination system and the projection apparatus provided by the embodiments of the disclosure have at least one of the following advantages: the light source module simultaneously provides the first laser beam and the second laser beam, and the second laser beam directly passes through the light splitting element as a part of the illumination beam to supplement the light in the overlapping wavelength range of the second converted beam.

Compared to an existing projector device that only uses a wavelength conversion device to provide illumination light with different colors, the disclosure uses a combination of the first laser beam, the second converted beam, and the second laser beam to not only achieve the color gamut range required for projectors but also enhance the beam brightness in the required wavelength range of the illumination beam.

Moreover, since the first laser beam and the second laser beam both exit the light splitting element through the second portion of the light splitting element. That is, the positions of the first laser beam and the second laser beam emitted from the light source system are within the same area of the illumination beam, the image beam projected from the projection apparatus has better color uniformity.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram showing the projection apparatus according to some embodiments of the disclosure.

FIG. 2A to FIG. 2D are diagrams showing the optical path of the projection apparatus according to the first embodiment of the disclosure.

FIG. 2E is a planar diagram showing the light source module according to the first embodiment.

FIG. 2F is a planar diagram showing the wavelength conversion element according to the first embodiment.

FIG. 2G is a diagram showing the side view of the light splitting element and the optical path according to the first embodiment.

FIG. 2H is a diagram showing the side view of the light splitting element and the optical path according to an embodiment of the disclosure.

FIG. 3A is a diagram showing the optical path of the projection apparatus according to the second embodiment of the disclosure.

FIG. 3B is a planar diagram showing the rotating wheel device according to the second embodiment.

FIG. 4A is a light emission time period diagram of the illumination system according to an embodiment of the disclosure.

FIG. 4B is a light emission time period diagram of the illumination system according to another embodiment of the disclosure.

FIG. 4C is a light emission time period diagram of the illumination system according to yet another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to.” Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

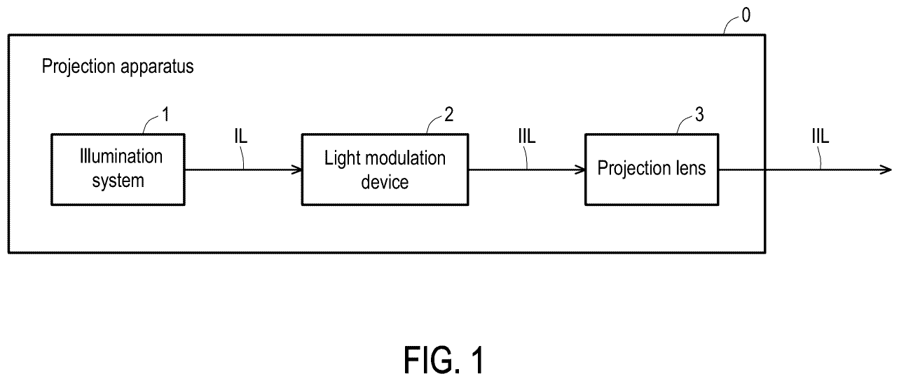

Referring to FIG. 1, a projection apparatus 0 includes an illumination system 1, a light modulation device 2, and a projection lens 3. The illumination system 1 is configured to provide an illumination beam IL. The light modulation device 2 is disposed on the transmission path of the illumination beam IL and configured to convert the illumination beam IL into an image beam IIL. The projection lens 3 is disposed on the transmission path of the image beam IIL and configured to project the image beam IIL out of the projection apparatus 0.

The light modulation device 2 may be, for example, a Liquid Crystal on Silicon panel (LCoS panel), a Digital Micro-mirror Device (DMD), or other reflective light modulators. In some embodiments, the light modulation device 2 may also be a Transparent Liquid Crystal Panel, an Electro-Optical Modulator, a Magneto-Optic modulator, an Acousto-Optic Modulator (AOM), or other transmissive light modulators. The disclosure is not intended to limit the form and type of the light modulation device 2. As to the method by which the light modulation device 2 converts the illumination beam IL into the image beam IIL, the detailed steps and implementations have been sufficiently taught, suggested, and described by the ordinary knowledge in the art, and therefore will not be described in detail here.

The projection lens 3 may include, for example, one optical lens or a combination of multiple optical lenses with refractive power, such as various combinations of non-planar lenses including biconcave lenses, biconvex lenses, concavo-convex lenses, convexo-concave lenses, plano-convex lenses, and plano-concave lenses. In an embodiment, the projection lens 3 may also include a planar optical lens to project the image beam IIL from the light modulation device 2 onto a projection target by reflection. The disclosure does not intend to limit the form and type of the projection lens 3.

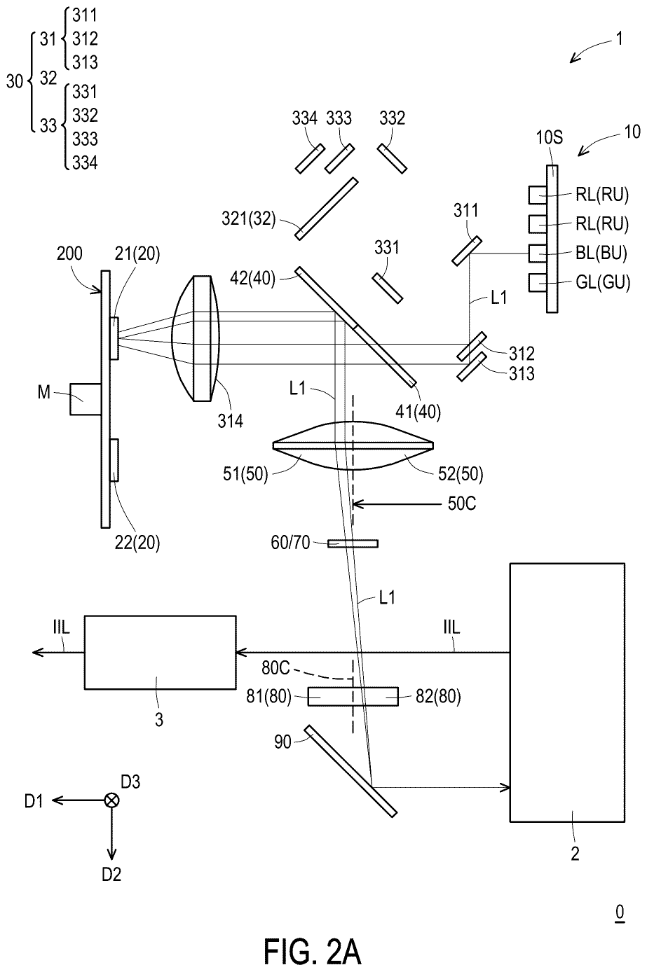

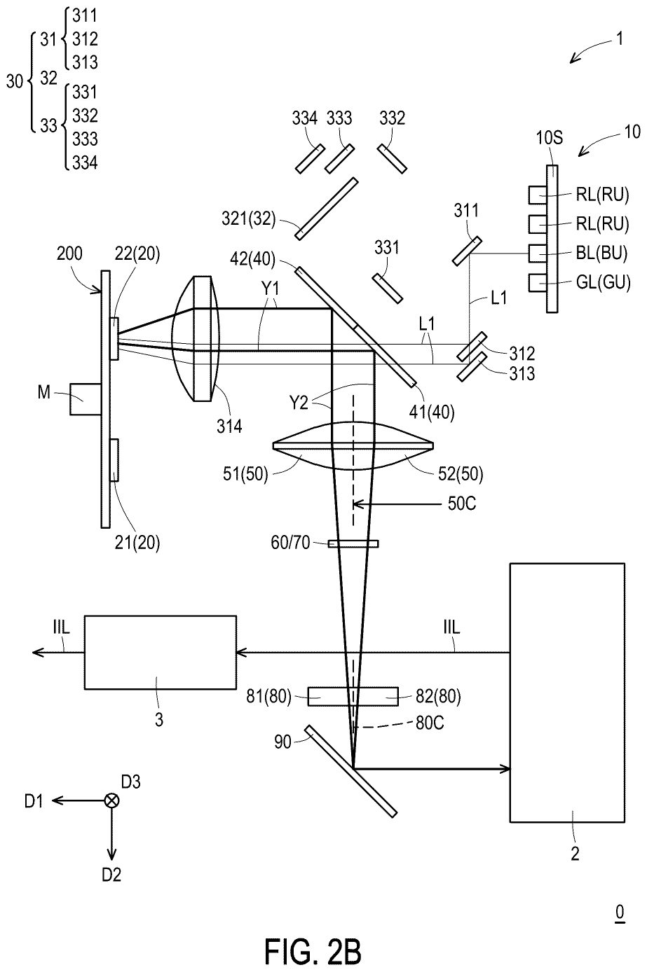

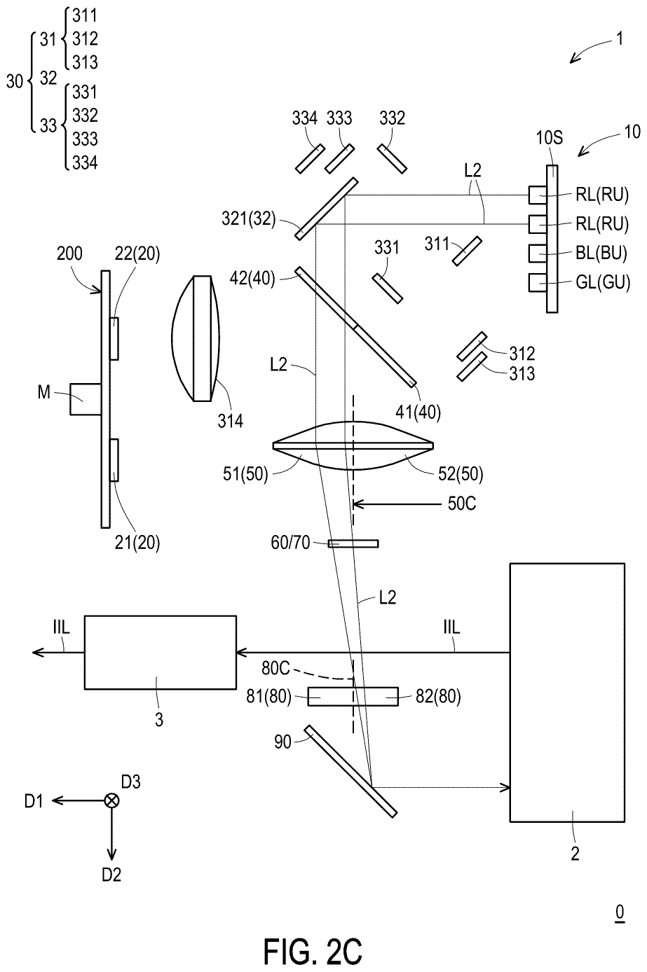

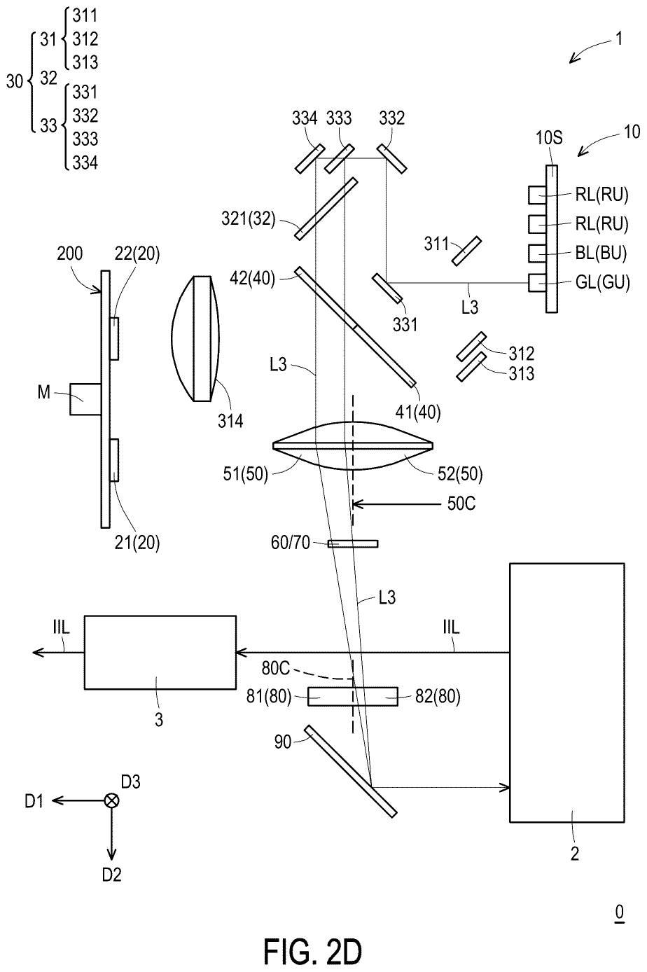

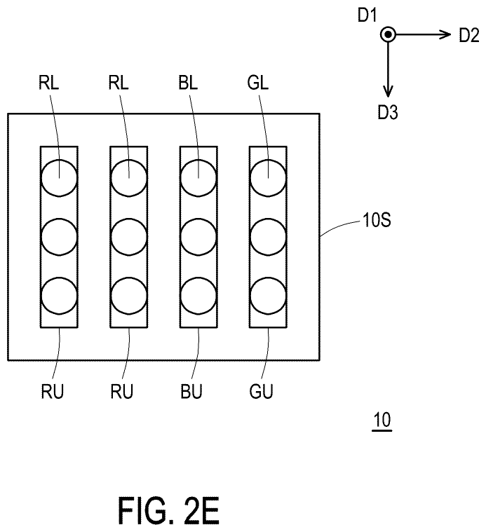

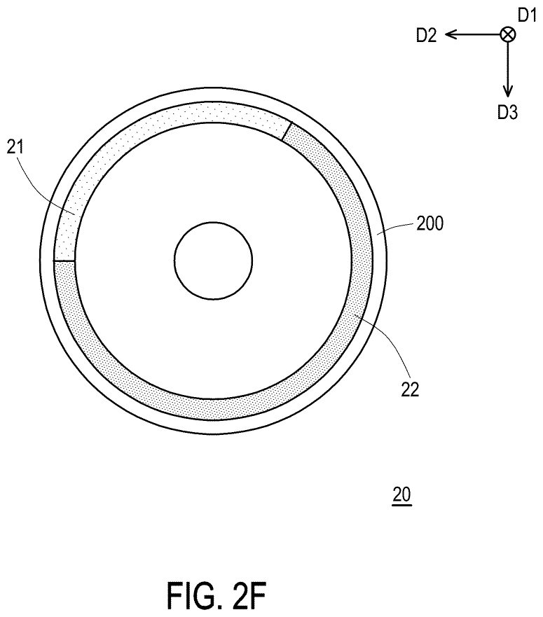

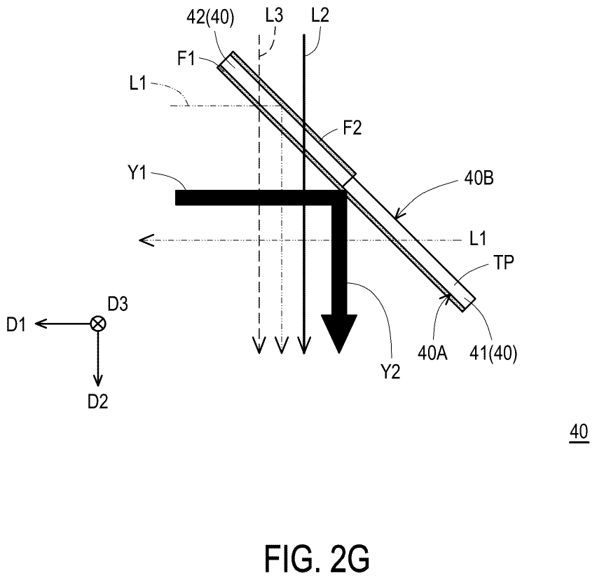

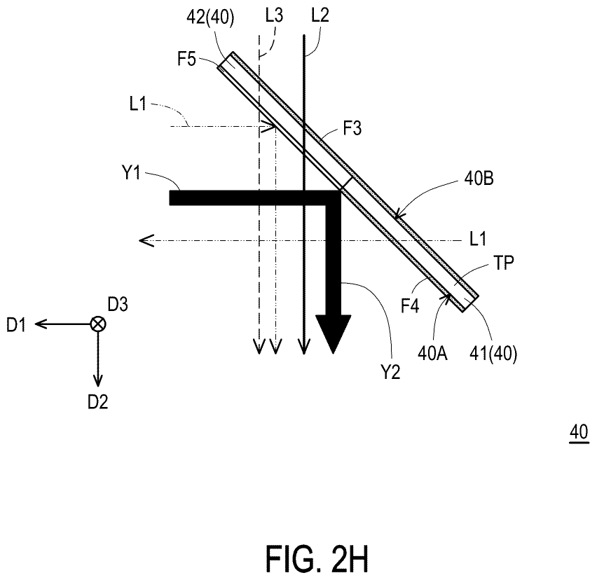

Referring to FIG. 2A, the projection apparatus 0 of the first embodiment includes an illumination system 1, a light modulation device 2, and a projection lens 3.

Referring to FIG. 2A to FIG. 2D, the illumination system 1 of the first embodiment includes a light source module 10, a wavelength conversion element 20, a light splitting/combining module 30, and a light splitting element 40, wherein the light splitting element 40 includes a first portion 41 and a second portion 42 disposed adjacent to each other. The arrangement direction of the first portion 41 and the second portion 42 of the light splitting element 40 is at 45 degrees with respect to the second direction D2. The light source module 10 includes multiple light emitting elements, such as Light Emitting Diodes (LEDs), Laser Diodes (LDs), or a combination of both.

Referring to FIG. 2A and FIG. 2E, in this embodiment, the light source module 10 includes a first laser light emitting unit BU, two second laser light emitting units RU, and a third laser light emitting unit GU. The two second laser light emitting units RU, the first laser light emitting unit BU, and the third laser light emitting unit GU are arranged sequentially along the second direction D2, with a spacing in the second direction between any two adjacent laser light emitting units. Each second laser light emitting unit RU includes multiple second laser light emitting elements RL arranged along the third direction D3. The first laser light emitting unit BU includes multiple first laser light emitting elements BL arranged along the third direction D3. The third laser light emitting unit GU includes multiple third laser light emitting elements GL arranged along the third direction D3, wherein the third direction D3 is perpendicular to the second direction D2. It should be noted that the number of laser light emitting elements in each of the above-mentioned laser light emitting units is not limited to 3 as shown in FIG. 2E.

It should be noted that in this embodiment, the light source module 10 is illustrated as including the first laser light emitting unit BU, the second laser light emitting units RU, and the third laser light emitting unit GU, but the disclosure is not limited thereto. The disclosure may include only the first laser light emitting unit BU and the second laser light emitting units RU, while still achieving all the effects described in the disclosure. Additionally, all the laser light emitting units of the light source module 10 are disposed in the same light source package. For example, all the laser light emitting units are fixed on the same substrate 10S (as shown in FIG. 2E) according to the above-mentioned configuration relationship.

As shown in FIG. 2A and FIG. 2B, each first laser light emitting element BL may provide a first laser beam L1 along the first direction D1. As shown in FIG. 2C, each second laser light emitting element RL may provide a second laser beam L2 along the first direction D1. As shown in FIG. 2D, each third laser light emitting element GL may provide a third laser beam L3 along the first direction D1, wherein the first direction D1, the second direction D2, and the third direction D3 are perpendicular to each other.

The wavelength conversion element 20 includes a rotating disc device 200 and a motor M. The rotating disc device 200 includes a central axis (not labeled), and the motor M is disposed on the central axis of the rotating disc device 200 to drive the rotating disc device 200 to rotate with the central axis as the rotation axis. The wavelength conversion element 20 includes a non-wavelength conversion area 21 and a wavelength conversion area 22 disposed on the rotating disc device 200. The non-wavelength conversion area 21 and the wavelength conversion area 22 are jointly configured in an annular shape with the central axis of the rotating disc device 200 as the center. The rotating disc device 200 may be, for example, a metal disc or a light transmissive disc with a reflective film layer, wherein a reflective film layer may also be disposed on the metal disc to enhance light reflectivity. No wavelength conversion material is disposed in the non-wavelength conversion area 21, while at least one type of wavelength conversion material is disposed in the wavelength conversion area 22. The wavelength conversion material may be, for example, fluorescent powder or phosphorescent powder, which converts the entering beam into a beam with longer wavelength by laser excitation. When the rotating disc device 200 rotates, the non-wavelength conversion area 21 and the wavelength conversion area 22 enter the transmission path of the first laser beam L1 at different time periods. The non-wavelength conversion area 21 is configured to reflect the first laser beam L1 (as shown in FIG. 2A). More specifically, after the first laser beam L1 is incident on the non-wavelength conversion area 21, the first laser beam L1 is reflected by the reflective layer or metal substrate on the rotating disc device. The wavelength conversion area 22 is configured to convert the first laser beam L1 to generate a first converted beam Y1 (as shown in FIG. 2B). The wavelength range of the first converted beam Y1 partially overlaps with the wavelength ranges of the second laser beam L2 and the third laser beam L3, respectively. For example, the wavelength ranges of the first laser beam L1, the second laser beam L2, and the third laser beam L3 do not overlap with each other.

For example, the wavelength range of the first laser beam L1 may be 450 nm to 475 nm (blue light), the wavelength range of the second laser beam L2 may be 630 nm to 655 nm (red light), the wavelength range of the third laser beam L3 may be 515 nm to 540 nm (green light), and the wavelength range of the first converted beam Y1 may be 530 nm to 780 nm, but the disclosure is not limited thereto. For instance, the wavelength ranges of the first laser beam L1, the second laser beam L2, and the third laser beam L3 may be interchanged with each other.

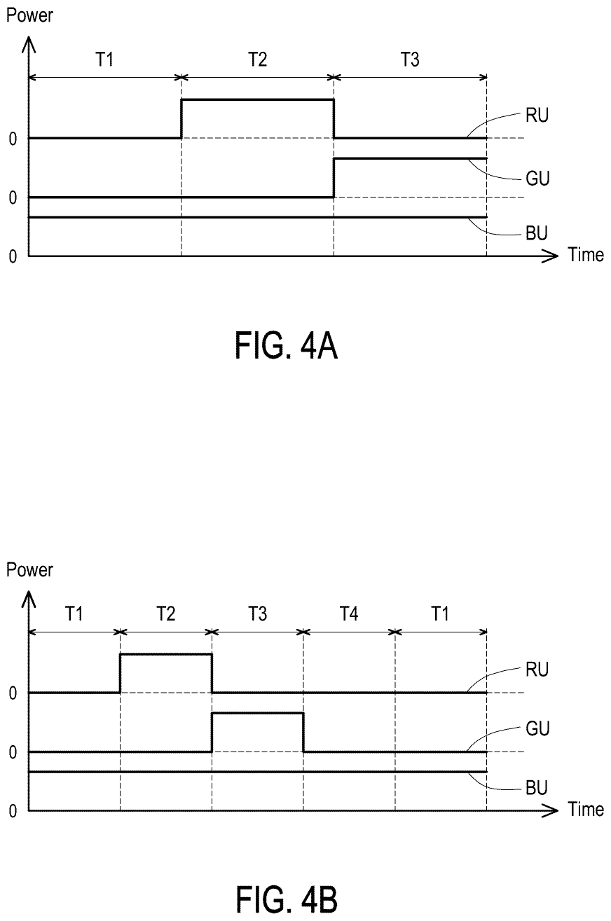

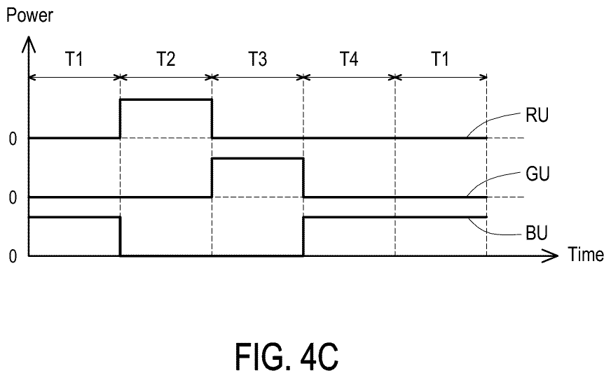

FIG. 4A is a light emission time period diagram of the illumination system according to an embodiment of the disclosure. Referring to FIG. 2A to FIG. 2D and FIG. 4A, when the illumination system 1 is operating, the first laser light emitting unit BU, two second laser light emitting units RU, and the third laser light emitting unit GU emit lights at different time periods corresponding to the wavelength conversion element 20 within one rotation time period, thereby providing different colored lights as the illumination beam at different time periods. In the embodiment of FIG. 4A, one complete time period includes a first time period T1, a second time period T2, and a third time period T3. The first time period T1 corresponds to the time period of the non-wavelength conversion area 21 of the wavelength conversion element 20. That is, the non-wavelength conversion area 21 of the wavelength conversion element 20 enters the transmission path of the first laser beam L1 in the first time period T1. The second time period T2 and the third time period T3 correspond to the time period of the wavelength conversion area 22 of the wavelength conversion element 20. That is, the wavelength conversion area 22 of the wavelength conversion element 20 enters the transmission path of the first laser beam L1 in the second time period T2 and the third time period T3. In the first time period T1, the first laser light emitting unit BU is turned on and provides the first laser beam L1, while the two second laser light emitting units RU and the third laser light emitting unit GU are turned off. In the second time period T2, the first laser light emitting unit BU and the two second laser light emitting units RU are simultaneously turned on and provide the first laser beam L1 and the second laser beam L2 respectively, while the third laser light emitting unit GU is turned off. In the third time period T3, the first laser light emitting unit BU and the third laser light emitting unit GU are simultaneously turned on and provide the first laser beam L1 and the third laser beam L3 respectively, while the two second laser light emitting units RU are turned off.

FIG. 4B is a light emission time period diagram of the illumination system according to another embodiment of the disclosure. Referring to FIG. 2A to FIG. 2D and FIG. 4B, when the illumination system 1 is operating, the first laser light emitting unit BU, two second laser light emitting units RU, and the third laser light emitting unit GU emit light beams in different time periods corresponding to the wavelength conversion element 20 within one rotation time period, thereby providing different colored lights as the illumination beam in different time periods. In the embodiment of FIG. 4B, one complete time period includes a first time period T1, a second time period T2, a third time period T3, and a fourth time period T4. The first time period T1 corresponds to the time period of the non-wavelength conversion area 21 of the wavelength conversion element 20. That is, the non-wavelength conversion area 21 of the wavelength conversion element 20 enters the transmission path of the first laser beam L1 in the first time period T1. The second time period T2, the third time period T3, and the fourth time period T4 correspond to the time period of the wavelength conversion area 22 of the wavelength conversion element 20. That is, the wavelength conversion area 22 of the wavelength conversion element 20 enters the transmission path of the first laser beam L1 in the second time period T2, the third time period T3, and the fourth time period T4. In the first time period T1, the first laser light emitting unit BU is turned on and provides the first laser beam L1, while the two second laser light emitting units RU and the third laser light emitting unit GU are turned off; in the second time period T2, the first laser light emitting unit BU and the two second laser light emitting units RU are simultaneously turned on and provide the first laser beam L1 and the second laser beam L2 respectively, while the third laser light emitting unit GU is turned off; in the third time period T3, the first laser light emitting unit BU and the third laser light emitting unit GU are simultaneously turned on and provide the first laser beam L1 and the third laser beam L3 respectively, while the two second laser light emitting units RU are turned off; and in the fourth time period T4, the first laser light emitting unit BU is turned on and provides the first laser beam L1, while the two second laser light emitting units RU and the third laser light emitting unit GU are turned off, and the wavelength conversion area 22 is configured to convert the first laser beam L1 to generate the first converted beam Y1.

FIG. 4C is a light emission time period diagram of the illumination system according to yet another embodiment of the disclosure. Referring to FIG. 2A to FIG. 2D and FIG. 4C, when the illumination system 1 is operating, the first laser light emitting unit BU, two second laser light emitting units RU, and the third laser light emitting unit GU emit lights at different time periods corresponding to the wavelength conversion element 20 within one rotation time period, thereby providing different colored lights as the illumination beam at different time periods. In the embodiment of FIG. 4C, one complete time period includes a first time period T1, a second time period T2, a third time period T3, and a fourth time period T4. The first time period T1 corresponds to the time period of the non-wavelength conversion area 21 of the wavelength conversion element 20. That is, the non-wavelength conversion area 21 of the wavelength conversion element 20 enters the transmission path of the first laser beam L1 in the first time period T1; the second time period T2, the third time period T3, and the fourth time period T4 correspond to the time period of the wavelength conversion area 22 of the wavelength conversion element 20. In the first time period T1, the first laser light emitting unit BU is turned on and provides the first laser beam L1, while the two second laser light emitting units RU and the third laser light emitting unit GU are turned off; in the second time period T2, the two second laser light emitting units RU are turned on and provide the second laser beam L2, while the first laser light emitting unit BU and the third laser light emitting unit GU are turned off, and in this time period, only the second laser beam L2 is emitted from the illumination system 1 as the illumination beam; in the third time period T3, the third laser light emitting unit GU is turned on and provides the third laser beam L3, while the first laser light emitting unit BU and the two second laser light emitting units RU are turned off, and in this time period, only the third laser beam L3 is emitted from the illumination system 1 as the illumination beam; and in the fourth time period T4, the first laser light emitting unit BU is turned on and provides the first laser beam L1, while the two second laser light emitting units RU and the third laser light emitting unit GU are turned off, and the wavelength conversion area 22 is configured to convert the first laser beam L1 to generate the first converted beam Y1.

The above content illustrates embodiments of the illumination system 1 with different light emission time periods. In each embodiment, the optical paths of the first laser beam L1, the second laser beam L2, and the third laser beam L3 within the illumination system 1 after being emitted from the light source module 10 are the same. Therefore, the subsequent explanation of the optical path of each beam in the illumination system 1 will only use the light emission time period of FIG. 4A as an example.

Referring to FIG. 2A, the light splitting/combining module 30 includes a first laser guiding assembly 31 configured to guide the first laser beam L1 to the first portion 41 of the light splitting element 40. Specifically, the first laser guiding assembly 31 includes a first laser reflecting mirror 311, a first laser beam splitter 312, and a first laser reflecting mirror 313. The first laser beam L1 provided by each first laser light emitting element BL and transmitted along the first direction D1 is reflected by the first laser reflecting mirror 311, and then transmitted along the second direction D2. The first laser beam splitter 312 partially transmits and partially reflected the first laser beam L1. The first laser reflecting mirror 313 is configured to reflect the first laser beam L1 that has pass through the first laser beam splitter 312. The first laser beam L1 reflected by the first laser beam splitter 312 and the first laser reflecting mirror 313 is transmitted along the first direction D1 to the first portion 41 of the light splitting element 40 and passes through the first portion 41 of the light splitting element 40, and is then transmitted through a lens 314 to the wavelength conversion element 20. It should be noted that, by disposing the first laser beam splitter 312 and the first laser reflecting mirror 313, the beam width of the first laser beam L1 may be expanded and the position may be adjusted, so that the spot width and position of the first laser beam L1 on the first portion 41 of the light splitting element 40 may be adjusted. Here, the spot width of the first laser beam L1 on the first portion 41 of the light splitting element 40 is defined as the first spot width.

The following uses the embodiment of the light emission time period of FIG. 4A to further describe the specific operation of the illumination system 1 in different time periods.

Referring to both FIG. 2A and FIG. 2F, in the first time period T1, when the first laser beam L1 is transmitted through the first portion 41 of the light splitting element 40 to the wavelength conversion element 20, the non-wavelength conversion area 21 enters the transmission path of the first laser beam L1. The first laser beam L1 is reflected by the non-wavelength conversion area 21. After the first laser beam L1 passes through the lens 314, the first laser beam L1 is transmitted to the second portion 42 of the light splitting element 40. The first laser beam L1 is then reflected by the second portion 42, and exits the light splitting element 40 along the second direction D2 to serve as the illumination beam IL in the first time period T1 and be emitted from the illumination system 1.

Referring to both FIG. 2B and FIG. 2F, in the second time period T2, when the first laser beam L1 is transmitted through the first portion 41 of the light splitting element 40 to the wavelength conversion element 20, the wavelength conversion area 22 of the wavelength conversion element 20 enters the transmission path of the first laser beam L1. The first laser beam L1 is converted to generate the first converted beam Y1. After passing through the lens 314, the first converted beam Y1 is transmitted to the first portion 41 and the second portion 42 of the light splitting element 40. The first portion 41 and the second portion 42 reflect at least a part of the first converted beam Y1 to generate a second converted beam Y2. The second converted beam Y2 exits the light splitting element 40 along the second direction D2.

Referring to FIG. 2C, the light splitting/combining module 30 further includes a second laser guiding assembly 32, which includes a second laser reflecting mirror 321. In the second time period T2, each second laser light emitting element RL provides the second laser beam L2 along the first direction D1. The second laser reflecting mirror 321 is configured to reflect the second laser beam L2, thereby converting the transmission direction of the second laser beam L2 from the first direction D1 to the second direction D2, and guiding the second laser beam L2 to the second portion 42 of the light splitting element 40. After passing through the second portion 42, the second laser beam L2 exits the light splitting element 40 along the second direction D2. The second laser beam L2 and the second converted beam Y2 serve as the illumination beam IL in the second time period T2 to be emitted from the illumination system 1. The combination of the second laser beam L2 and the second converted beam Y2 may achieve the required color point of colored light and enhance the beam energy intensity of the illumination beam IL within the wavelength range of the second laser beam L2 in the second time period T2.

It should be noted that, by disposing the second laser reflecting mirror 321, the spot width and position of the second laser beam L2 on the second portion 42 of the light splitting element 40 may be adjusted. Here, the spot width of the second laser beam L2 on the second portion 42 of the light splitting element 40 is defined as the second spot width. It should also be noted that, in this embodiment, the light source module 10 includes two second laser light emitting units RU arranged along the second direction D2, so the beam width of the second laser beam L2 in the second direction D2 is greater than the beam width of the first laser beam L1 or the third laser beam L3 in the second direction D2 in the original beam generated by the light source module 10. By adjusting the beam width, the first spot width, and position of the first laser beam L1 through the first laser guiding assembly 31, the first spot width of the first laser beam L1 may correspond to the second spot width of the second laser beam L2, and the spot position formed by the first laser beam L1 on the second portion 40 of the light splitting element 40 after being reflected by the wavelength conversion element 20 may correspond to the spot position formed by the second laser beam L2 on the second portion. In other words, the spot width and position formed by the first laser beam L1 on the second portion of the light splitting element 40 are approximately the same as the spot width and position formed by the second laser beam L2 on the light splitting element 40. Accordingly, the first laser beam L1 and the second laser beam L2 in the illumination beam IL exiting the light splitting element 40 may possess consistent beam width and optical path in different time periods. That is, the optical paths of the first laser beam L1 and the second laser beam L2 exiting the second portion 42 of the light splitting element 40 overlap, which ensures a consistent optical path distribution of the first laser beam L1 and the second laser beam L2 in the illumination beam IL, thereby improving the overall color uniformity of subsequent imaging.

Referring to FIG. 2B, in the third time period T3, the first laser light emitting unit BU continues to emit light, and the wavelength conversion area 22 of the wavelength conversion element 20 remains in the transmission path of the first laser beam L1. Therefore, similar to the second time period T2, the second converted beam Y2 is generated and exits the light splitting element 40 along the second direction D2.

Referring to FIG. 2D, the light splitting/combining module 30 further includes a third laser guiding assembly 33. The third laser guiding assembly 33 includes a third laser reflecting mirror 331, a third laser reflecting mirror 332, a third laser beam splitter 333, and a third laser reflecting mirror 334. In the third time period T3, each third laser light emitting element GL provides the third laser beam L3 along the first direction D1. After the third laser beam L3 is reflected by the third laser reflecting mirror 331, the third laser beam L3 is transmitted in the reverse direction along the second direction D2. After the third laser beam L3 is reflected by the third laser reflecting mirror 332, the third laser beam L3 is transmitted along the first direction D1. The third laser beam splitter 333 is configured to partially transmit and partially reflect the third laser beam L3, and the third laser reflecting mirror 334 is configured to reflect the third laser beam L3 that passes through the third laser beam splitter 333. The third laser beam L3 reflected by the third laser beam splitter 333 and the third laser reflecting mirror 334 passes through the second laser reflecting mirror 321 along the second direction D2 and is then transmitted to the second portion 42 of the light splitting element 40. After the third laser beam L3 passes through the second portion 42, the third laser beam L3 exits the light splitting element 40 along the second direction D2. The third laser beam L2 and the second converted beam Y2 serve as the illumination beam IL in the third time period T3, and are emitted from the illumination system 1. The combination of the third laser beam L2 and the second converted beam Y2 may achieve the required color point of colored light and enhance the energy intensity of the illumination beam IL within the wavelength range of the third laser beam L3 in the third time period T3.

It should be noted that, in this embodiment, in the original beam generated by the light source module 10, the beam width of the second laser beam L2 in the second direction D2 is greater than the beam width of the third laser beam L3 in the second direction D2, for example, twice as wide. Therefore, by disposing the third laser beam splitter 333 and the third laser reflecting mirror 334, the beam width and position of the third laser beam L3 and the spot width and position on the second portion 42 of the light splitting element 40 may be adjusted, which ensures that the third spot width of the third laser beam L3 on the second portion 42 of the light splitting element 40 is approximately the same as and corresponds in position to the second spot width formed by the second laser beam L2 on the second portion 42. In other words, the light spot formed by the third laser beam L3 on the light splitting element 40 has approximately the same width and position as the light spot formed by the second laser beam L2 on the light splitting element 40. That is, the optical paths of the second laser beam L2 and the third laser beam L3 exiting the second portion 42 of the light splitting element 40 overlap. Accordingly, the illumination beam IL may possess consistent beam width and optical path in different time periods, which ensures a uniform distribution of the first laser beam L1 to the third laser beam L3 in the illumination beam IL, thereby improving the overall color uniformity of subsequent imaging.

The following further describes the specific structure of the light splitting element 40 in this embodiment.

Referring to FIG. 2G, in the first embodiment, the light splitting element 40 includes a light transmitting substrate TP, which has a first surface 40A and a second surface 40B opposite to the first surface 40A. A converted beam reflecting coating F1 is disposed on the first surface 40A corresponding to the first portion 41 and the second portion 42. The converted beam reflecting coating F1 is configured to reflect the second converted beam Y2 and allow other beams to pass through. In some embodiments, the reflection wavelength range corresponding to the converted beam reflecting coating F1 partially overlaps with the wavelength range of the first converted beam Y1. For example, the converted beam reflecting coating F1 may have a lower reflectivity in the wavelength bands of the second laser beam L2 and the third laser beam L3. In this case, the wavelength range of the second converted beam Y2 is smaller than the wavelength range of the first converted beam Y1. In other words, a part of the first converted beam Y1 is reflected by the converted beam reflecting coating F1 and forms the second converted beam Y2, while another part of the first converted beam Y1 passes through the converted beam reflecting coating F1 and the light transmitting substrate TP.

Also referring to FIG. 2G, a first laser reflecting coating F2 is disposed on the second surface 40B corresponding to the second portion 42. The first laser reflecting coating F2 is configured to reflect the first laser beam L1 and allow other beams to pass through. The first laser beam L1 reflected by the wavelength conversion element 20 passes through the first laser reflecting coating F2 on the second surface 40B of the light splitting element 40 corresponding to the second portion 42 and the light transmitting substrate TP, then is reflected by the first laser reflecting coating F2 on the first surface 40A, and exits the light splitting element 40 along the second direction D2. In this embodiment, the converted beam reflecting coating F1 may have a lower reflectivity in the wavelength bands of the second laser beam L2 and the third laser beam L3. Accordingly, at least a part of the second laser beam L2 and the third laser beam L3 may pass through the first laser reflecting coating F2, the light transmitting substrate TP, and the converted beam reflecting coating F1 in the second portion 42, thus forming a part of the illumination beam IL. In this approach, the same converted beam reflecting coating F1 is disposed on the first surface 40A of the first portion 41 and the second portion 42 of the light splitting element 40, thereby simplifying the manufacturing process and reducing the production cost of the light splitting element 40.

Referring to FIG. 2H, in some other embodiments, a first laser transmitting coating F4 is disposed on the first surface 40A of the light splitting element 40 corresponding to the first portion 41, and is configured to allow the first laser beam L1 to pass through and reflect other beams. A first laser reflecting coating F5 is disposed on the first surface 40A corresponding to the second portion 42. The first laser reflecting coating F5 is configured to reflect the first laser beam L1 and allow other beams to pass through, thus allowing the second laser beam L2 and the third laser beam L3 to pass through.

An anti-reflection coating F3 is disposed on the second surface 40B of the light splitting element 40 corresponding to the first portion 41 and the second portion 42, which may increase the penetration rate of the first laser beam L1 when passing through the first portion 41, and increase the penetration rate of the second laser beam L2 and the third laser beam L3 when passing through the second portion 42. In this approach, only a basic anti-reflection coating is disposed on the second surface 40B corresponding to the first portion 41 and the second portion 42, thereby simplifying the manufacturing process and reducing the production cost of the light splitting element 40.

Referring to FIG. 2A to FIG. 2D again, the illumination system 1 further includes an beam output lens 50. The beam output lens 50 has an optical axis 50C. The beam output lens 50 is divided into a first area 51 and a second area 52 on both sides with the optical axis 50C as the center, corresponding to the first portion 41 and the second portion 42 of the light splitting element 40 in the second direction D2, respectively. As shown in FIG. 2A, FIG. 2C, and FIG. 2D, the first laser beam L1, the second laser beam L2, and the third laser beam L3 all exit the light splitting element 40 from the second portion 42 of the light splitting element 40, and all pass through the first area 51 of the beam output lens 50, without passing through the second area 52 of the beam output lens 50. On the other hand, the second converted beam Y2 exits the light splitting element 40 from the first portion 41 and the second portion 42 of the light splitting element 40, and passes through the first area 51 and the second area 52 of the beam output lens 50.

In addition, the illumination system 1 may also include at least one of a diffusion element 60 and an optical filtering element 70. The diffusion element 60 is configured to perform uniform light diffusion on the illumination beam IL from the beam output lens 50, and the optical filtering element 70 is configured to perform optical filtering on the illumination beam IL from the beam output lens 50, thereby extracting the colored light beam of the required wavelength range. Since the disclosure provides the second laser beam L2 (for example, red light) and the third laser beam L3 (for example, green light) as supplementary beams for the corresponding wavelength ranges, the illumination system may not use the optical filtering element 70, but only use the diffusion element 60 to provide beams of different wavelength ranges in different time periods for the illumination beam IL.

Referring to FIG. 2A to FIG. 2D, the projection apparatus 0 of the first embodiment may further include a homogenizing element 80 and a reflecting mirror 90, wherein the homogenizing element 80 may be, for example, a fly-eye lens. The homogenizing element 80 is disposed on the transmission path of the illumination beam IL, for example, on the transmission path after the illumination beam IL passes through the beam output lens 50 and the diffusion element 60 or the optical filtering element 70. The homogenizing element 80 has a central axis 80C and a first side portion 81 and a second side portion 82 located on opposite sides of the central axis 80C, respectively. The first laser beam L1, the second laser beam L2, and the third laser beam L3 serving as the illumination beam IL pass through the second side portion 82 of the homogenizing element 80, without passing through the first side portion 81. On the other hand, the second converted beam Y2 serving as the illumination beam IL passes through the first side portion 81 and the second side portion 82 of the homogenizing element 80. The illumination beam IL that passes through the homogenizing element 80 is reflected by the reflecting mirror 90 and then incident on the light modulation device 2. The light modulation device 2 may include, for example, a digital micro-mirror device, configured to modulate the illumination beam IL into the image beam IIL. The projection lens 3 is disposed on the transmission path of the image beam IIL and configured to project the image beam IIL out of the projection apparatus 0.

It should be noted that, since the directions and positions of the first laser beam L1, the second laser beam L2, and the third laser beam L3 are adjusted through the above-mentioned component configuration of the light splitting/combining module 3, the arrangement positions and directions of the first laser light emitting element BL, the second laser light emitting element RL, and the third laser light emitting element GL are not limited by the directions and positions of entering the light splitting element 40. Therefore, the light source module 10 of the projection apparatus 0 may be disposed in the same light source package. Compared to the existing technology in which the first laser light emitting element BL, the second laser light emitting element RL, and the third laser light emitting element GL need to be arranged in multiple packaged light source modules according to different directions and positions of different beams, the configuration of the disclosure simplifies the configuration space of the light source module and simplify the heat dissipation device of the light source module, thereby reducing the volume of the illumination system 1 and the projection apparatus 0. In addition, the spot widths and positions of the first laser beam L1, the second laser beam L2, and the third laser beam L3 on the second portion 42 of the light splitting element 40 may be correspondingly arranged, so that the first to third laser beams L1, L2, and L3 in the illumination beam IL have fixed beam widths and ranges. Thus, when the illumination beam IL is subsequently processed into the image beam IIL and projected by the projection lens 3, the loss ratios of the first to third laser beams L1, L2, and L3 due to edge reduction are the same, thereby optimizing the uniformity of the image beam IIL.

In order to fully illustrate various embodiments of the disclosure, other embodiments of the disclosure will be described below. It should be noted that the following embodiments also use the reference numerals and part of the content from the previous embodiments, wherein the same reference numerals represent the same or similar elements, and the description of the same technical content is omitted. Please refer to the previous embodiments for the omitted content which will not be repeated hereinafter.

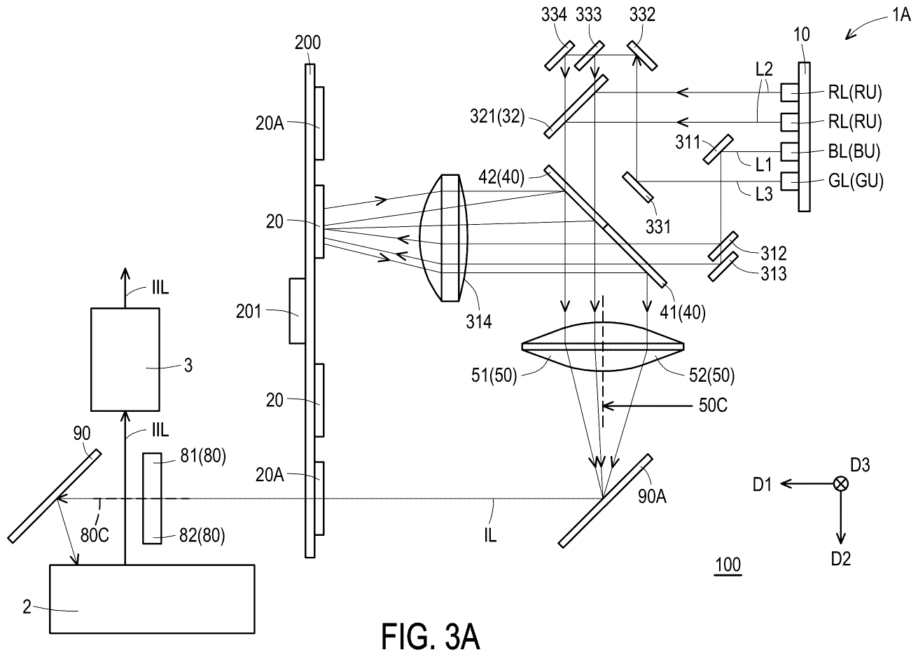

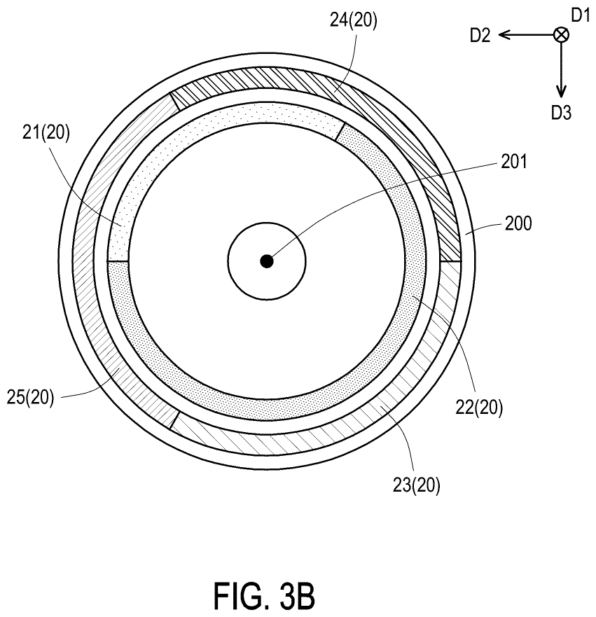

Referring to FIG. 3A and FIG. 3B, a projection apparatus 100 of the second embodiment includes an illumination system 1A, a light modulation device 2, and a projection lens 3.

The main difference between the illumination system 1A of the second embodiment and the illumination system 1 of the first embodiment is that the illumination system 1A further includes a reflection element 90A, and the wavelength conversion element 20 includes an optical filtering element 20A disposed on a rotating disc device 200. The reflection element 90A is disposed on the transmission path of the illumination beam IL and configured to redirect the transmission direction of the illumination beam IL from the beam output lens 50 to the first direction D1. The optical filtering element 20A is disposed on the rotating disc device 200 and radially surrounds the outer side of the non-wavelength conversion area 21 and the wavelength conversion area 22. In this embodiment, the reflection element 90A is configured to redirect the illumination beam to transmit in the same first direction D1 as the first laser beam L1 when entering the wavelength conversion element 20, so the wavelength conversion element 20 and the optical filtering element 20A may be configured coplanar and thus disposed on the same rotating disc device 200. As a result, the number of rotating elements in the projection apparatus 0 can be reduced to lower the cost and reduce the overall volume.

The following further describes the specific configuration of the optical filtering element 20A on the wavelength conversion element 20.

As shown in FIG. 3B, the optical filtering element 20A has a first optical filtering area 23, a second optical filtering area 24, and a third optical filtering area 25. The first optical filtering area 23, the second optical filtering area 24, and the third optical filtering area 25 are arranged in a circular ring shape, and the non-wavelength conversion area 21 and the wavelength conversion area 22 of the wavelength conversion element 20 are also arranged in a circular ring shape. The circular ring shape of the first optical filtering area 23, the second optical filtering area 24, and the third optical filtering area 25 shares a common central axis with the non-wavelength conversion area 21 and the wavelength conversion area 22, which is the central axis 201 of the rotating disc device 200.

It should be noted that, in the rotating disc device 200 shown in FIG. 3B, the non-wavelength conversion area 21 and the wavelength conversion area 22 are arranged on the inner circular ring shape with a smaller diameter, while the optical filtering element 20A is arranged on the outer circular ring shape with a larger diameter. Moreover, the reverse arrangement may also be possible.

Referring to both FIG. 4A and FIG. 3B, specifically, the first filtering wavelength range of the first optical filtering area 23 at least partially overlaps with the wavelength range of the first laser beam L1, for example, corresponding to or including the wavelength range of the first laser beam L1. In the first time period T1, the first laser beam L1 serves as the illumination beam IL and the first optical filtering area 23 enters the transmission path of the illumination beam IL, and at least a part of the first laser beam L1 may pass through the first optical filtering area 23.

The second filtering range of the second optical filtering area 24 at least partially overlaps with the wavelength range of the second laser beam L2, for example, corresponding to or including the wavelength range of the second laser beam L2. In the second time period T2, when at least one of the second laser beam L2 and the second converted beam Y2 serves as the illumination beam IL, the second optical filtering area 24 enters the transmission path of the illumination beam IL, allowing the component of the illumination beam IL that corresponds to or includes the wavelength range of the second laser beam L2 to pass through.

The third filtering range of the third optical filtering area 25 at least partially overlaps with the wavelength range of the third laser beam L3, for example, corresponding to or including the wavelength range of the third laser beam L3. In the third time period T3, when at least one of the third laser beam L3 and the second converted beam Y2 serves as the illumination beam IL, the third optical filtering area 25 enters the transmission path of the illumination beam IL, allowing the component of the illumination beam IL that corresponds to or includes the wavelength range of the third laser beam L3 to pass through.

As mentioned above, the disclosure may also be implemented without using an optical filtering element. Therefore, the optical filtering element 20A on the wavelength conversion element 20 may be replaced by the diffusion element 60. In other words, the aforementioned first optical filtering area 23, second optical filtering area 24, and third optical filtering area 25 may be replaced by diffusion areas, which are configured to uniformly diffuse the illumination beam IL from the reflection element 90A.

In summary, the illumination system and the projection apparatus provided by the embodiments of the disclosure have at least one of the following advantages: (1) the light source module of the illumination system may be disposed within the same light source package, which significantly reduces the volume of the illumination system and the projection apparatus; and (2) the spot widths and positions of the first laser beam, the second laser beam, and the third laser beam on the second portion of the light splitting element may be configured to be substantially the same, so that the illumination beam has a fixed beam width, thereby optimizing the uniformity of the image beam.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention,” “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first,” “second,” etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, configured to provide an illumination beam, wherein the illumination system comprises a light source module, a wavelength conversion element, a light splitting/combining module, and a light splitting element, wherein:
the light source module is configured to provide a first laser beam and a second laser beam to the light splitting/combining module along a first direction;
the wavelength conversion element comprises a wavelength conversion area and a non-wavelength conversion area, the wavelength conversion area and the non-wavelength conversion area are configured to enter a transmission path of the first laser beam from the light splitting/combining module in different time periods; the non-wavelength conversion area is configured to reflect the first laser beam, the wavelength conversion area is configured to convert the first laser beam to generate a first converted beam, a wavelength range of the first converted beam partially overlaps with a wavelength range of the second laser beam;
the light splitting element is disposed between the light splitting/combining module and the wavelength conversion element, wherein the light splitting element comprises a first portion and a second portion disposed adjacent to each other;
the light splitting/combining module is disposed between the light source module and the light splitting element, the light splitting/combining module is configured to transmit the first laser beam along the first direction to the first portion of the light splitting element, and swerve an optical path of the second laser beam so that the second laser beam transmits to the second portion of the light splitting element along a second direction, wherein the first direction is not parallel to the second direction;
the first portion of the light splitting element is configured to allow the first laser beam from the light splitting/combining module to pass through, the second portion of the light splitting element is configured to reflect the first laser beam from the wavelength conversion element and allow the second laser beam from the light splitting/combining module to pass through, and the first portion and the second portion are configured to reflect at least a part of the first converted beam from the wavelength conversion element to form a second converted beam; and
the first laser beam from the non-wavelength conversion area and the second laser beam exit the light splitting element along the second direction from the second portion of the light splitting element, the second converted beam exits the light splitting element along the second direction from the first portion and the second portion of the light splitting element, and at least one of the first laser beam, the second laser beam, and the second converted beam serves as the illumination beam and is emitted from the illumination system.

2. The illumination system according to claim 1, further comprising a beam output lens, wherein the beam output lens has an optical axis and is disposed on a transmission path of the first laser beam, the second laser beam, and the second converted beam from the light splitting element, the beam output lens is divided into a first area and a second area by the optical axis as a center on two sides of the optical axis; the optical paths of the first laser beam and the second laser beam exiting the second portion of the light splitting element overlap with each other, and the first laser beam and the second laser beam pass through the first area of the beam output lens and do not pass through the second area of the beam output lens.

3. The illumination system according to claim 1, wherein the light splitting/combining module comprises a first laser guiding assembly configured to guide the first laser beam to the first portion of the light splitting element, and a light spot formed by the first laser beam from the first laser guiding assembly on the first portion has a first spot width.

4. The illumination system according to claim 3, wherein the first laser guiding assembly comprises a first laser beam splitter and a first laser reflecting mirror, the first laser beam splitter allows the first laser beam to partially pass through and partially reflect, and the first laser reflecting mirror is configured to reflect a part of the first laser beam that passes through the first laser beam splitter, wherein the first laser beam reflected by the first laser beam splitter and the first laser reflecting mirror is transmitted to the first portion of the light splitting element along the first direction.

5. The illumination system according to claim 3, wherein the light source module further provides a third laser beam along the first direction, and the light splitting/combining module is configured to transmit the third laser beam along the second direction to the second portion of the light splitting element, wherein a wavelength range of the third laser beam is different from the wavelength range of the second laser beam.

6. The illumination system according to claim 1, wherein a wavelength range of the first laser beam is 450 nm to 475 nm, the wavelength range of the second laser beam is 630 nm to 655 nm or 515 nm to 540 nm, and the wavelength range of the first converted beam is 530 nm to 780 nm.

7. The illumination system according to claim 1, wherein the light source module is disposed in a same light source package.

8. The illumination system according to claim 5, wherein the light splitting/combining module further comprises a second laser guiding assembly configured to redirect a transmission direction of the second laser beam from the first direction to the second direction, and guide the second laser beam to the second portion of the light splitting element along the second direction, wherein a light spot formed by the second laser beam from the second laser guiding assembly on the second portion has a second spot width, and the first spot width corresponds to the second spot width.

9. The illumination system according to claim 8, wherein the second laser guiding assembly comprises a second laser reflecting mirror configured to reflect the second laser beam from the light source module to the second portion.

10. The illumination system according to claim 9, further comprising a third laser guiding assembly which comprises a third laser beam splitter and a third laser reflecting mirror, wherein the third laser beam splitter is configured to allow the third laser beam to partially pass through and partially reflect, the third laser reflecting mirror is configured to reflect a part of the third laser beam that passes through the third laser beam splitter, and
the third laser beam reflected by the third laser beam splitter and the third laser reflecting mirror passes through the second laser reflecting mirror along the second direction and is transmitted to the second portion of the light splitting element, wherein a light spot formed by the third laser beam from the third laser guiding assembly on the second portion has a third spot width, and the third spot width corresponds to the second spot width.

11. The illumination system according to claim 1, wherein the light splitting element comprises a light transmitting substrate which has a first surface and a second surface opposite to the first surface, wherein
a converted beam reflecting coating is disposed on the first surface corresponding to the first portion and the second portion, the converted beam reflecting coating is configured to reflect the second converted beam and allow other beams to pass through, a first laser reflecting coating is disposed on the second surface corresponding to the second portion, and the first laser reflecting coating is configured to reflect the first laser beam and allow other beams to pass through.

12. The illumination system according to claim 1, wherein the light splitting element comprises a light transmitting substrate which has a first surface and a second surface opposite to the first surface, wherein
an anti-reflection coating is disposed on the second surface corresponding to the first portion and the second portion, a first laser transmitting coating is disposed on the first surface corresponding to the first portion and configured to allow the first laser beam to pass through and reflect other beams, a first laser reflecting coating is disposed on the first surface corresponding to the second portion, and the first laser reflecting coating is configured to reflect the first laser beam and allow other beams to pass through.

13. The illumination system according to claim 5, wherein the light source module comprises a first laser light emitting unit, two second laser light emitting units, and a third laser light emitting unit configured to respectively provide the first laser beam, the second laser beam, and the third laser beam, wherein the two second laser light emitting units, the first laser light emitting unit, and the third laser light emitting unit are arranged along the second direction.

14. The illumination system according to claim 13, wherein each of the two second laser light emitting units comprises a plurality of second laser light emitting elements arranged along a third direction, the first laser light emitting unit comprises a plurality of first laser light emitting elements arranged along the third direction, and the third laser light emitting unit comprises a plurality of third laser light emitting elements arranged along the third direction, wherein the third direction is perpendicular to the second direction.

15. The illumination system according to claim 1, wherein an arrangement direction of the first portion and the second portion of the light splitting element is at 45 degrees with respect to the second direction.

16. The illumination system according to claim 2, further comprising a reflection element, wherein the reflection element is disposed on a transmission path of the illumination beam and configured to redirect a transmission direction of the illumination beam from the beam output lens to the first direction.

17. The illumination system according to claim 16, wherein the wavelength conversion element further comprises a diffusion element and a rotating disc device, the diffusion element has a diffusion area, the diffusion area is disposed on the transmission path of the illumination beam from the reflection element, and the diffusion element is configured to uniform and diffuse the illumination beam from the reflection element, and
the diffusion element is disposed on the rotating disc device and radially surrounds an outer side of the non-wavelength conversion area and the wavelength conversion area.

18. The illumination system according to claim 16, wherein the wavelength conversion element further comprises a diffusion element and a rotating disc device, the optical filtering element has a plurality of optical filtering areas, and the optical filtering areas comprise at least a first optical filtering area and a second optical filtering area,
the first optical filtering area has a first filtering wavelength range, the first optical filtering area enters the transmission path of the illumination beam from the reflection element when the first laser beam is the illumination beam, and the first filtering wavelength range at least partially overlaps with the wavelength range of the first laser beam;
the second optical filtering area has a second filtering wavelength range, the second optical filtering area enters the transmission path of the illumination beam from the reflection element when at least one of the second laser beam and the second converted beam is the illumination beam, and the second filtering wavelength range at least partially overlaps with the wavelength range of the second laser beam; and
the diffusion element is disposed on the rotating disc device and radially surrounds an outer side of the non-wavelength conversion area and the wavelength conversion area.

19. A projection apparatus, comprising the illumination system according to claim 1, a light modulation device, and a projection lens, wherein:
the illumination system is configured to provide the illumination beam, the light modulation device is disposed on the transmission path of the illumination beam and configured to convert the illumination beam into an image beam, and the projection lens is disposed on a transmission path of the image beam and configured to project the image beam out of the projection apparatus.

20. The projection apparatus according to claim 19, further comprising a homogenizing element, wherein the homogenizing element has a central axis and a first side portion and a second side portion respectively located on two opposite sides of the central axis, the first laser beam or the second laser beam passes through the second side portion of the homogenizing element as the illumination beam without passing through the first side portion, and the second converted beam passes through the first side portion and the second side portion of the homogenizing element as the illumination beam.
